(19) United States
(12) Patent Application Publication
(10) Pub. No.: US 2013/0335730 A1
(43) Pub. Date: Dec. 19, 2013

(54) Drift compensated optical current and voltage sensors with an electric reference channel

(71) Applicants: Xuekang SHAN, San Diego, CA (US); Jin HAO, San Diego, CA (US)

(72) Inventors: Xuekang SHAN, San Diego, CA (US); Jin HAO, San Diego, CA (US)

(21) Appl. No.: 13/525,332

(22) Filed: Jun. 17, 2012

(51) Int. Cl. G01N 21/00

(52) U.S. Cl. 356/72

(57) ABSTRACT

An electric reference signal channel is added to the main signal in a hybrid optical current sensor or voltage sensor. This reference signal has a frequency that is outside the main signal's frequency band. A summing integrator of a summing amplifier combines the reference signal with the main signal, and the combined signals drives an electro-optic device. This electro-optic device drives the input CW optical signal. An optical receiver converts the received optical signal into electric signal. Two band pass filters separate the main signal and the reference signal into their respective paths. A signal processing unit calculates the ratio of the main signal to the reference signal. Therefore, drifts in the optical source and all the optical path are factored out.

### REFERENCES CITED

U.S. Pat. No. 7,279,884

This invention relates to a method to introduce an electric reference channel to automatically compensate drifts in hybrid optical current sensors and voltage sensors.

### BACKGROUND OF THE INVENTION

Measuring current and voltage in high voltage (HV) environments is the daily necessity for the power industry. Current and voltage transformers for this type of measurements were invented and developed about a century ago. With the increase of the voltage and capacity in modern power generation and distribution systems, traditional iron core based current and voltage transformers are becoming more and more bulky and expensive, due to stringent requirements for insulation and safety. Fiber optic current and voltage transformers have been the subject for research and development for decades, due to their unparalleled advantages for applications in high voltage (HV) environments. This is simply because optical fibers are intrinsically excellent insulator, and are immune to electro magnetic interference.

Fiber optic current and voltage transformers can be generally classed into two categories: all optical and hybrid. The all optical type are typically based on the Faraday effect for current sensing and on Pockels cell for voltage sensing. The main advantage of this type of sensors is that the whole sensing head is passive and only fibers are connected to it. However, in practice, this type of sensors have met various difficulties leading to accuracy and stability problems. Up to date, this type of sensors have not been proved to be commercially successful.

On the other hand, the hybrid type combines the traditional current and voltage measuring methods with fiber optic devices. This type of sensors can be further divided into two sub types:

a. Optical fiber is used as pure transmission medium, and the whole sensing and signal processing in the sensing head are fully electrical. A light source is also contained in the sensor head. The main drawback of this design is the difficulty associated with supplying electric power to the active electronic circuits in the sensor head, normally of tens of mili watts. One of the drawbacks this type of sensors have is that it is difficult to supply power to the sensor head because it is at the HV side.

b. An electro-optic device is utilized in the sensing head to modulate the CW input light signal, and a typical example is using a Rogowski coil to detect the current in a power line. The voltage generated in the coil is then integrated and is applied to an electro-optic device which modulates the input CW light signal. Therefore, the received optical signal contains information about the current flowing in the power line. A ferrite core coil can also be used instead of an air core Rogowski coil, or even a shunt resistor can translate current into a voltage to drive the electro-optic device. In voltage sensors, one can use a condenser antenna to pick the electric field, or use a resistive or capacitive voltage divider to achieve a small voltage to drive the electro optic device.

The electro-optic device can be a MEMS fiber optic device which is often built in the form of a variable optical attenuator (VOA). When a voltage is applied to the VOA, it changes the optical attenuation to the input optical signal. In another form, this electro-optic device can be a lithium niobate crystal device, built in the form of electro-optic modulator. When a voltage is applied to this modulator, it changes the optical attenuation or the polarization state of the input optical signal. Compared to sub type a, sub type b has some advantages, such as simpler HV side circuitry and hence higher reliability. The most significant advantage is that the sensor head consumes very low electric power, normally at micro watts level, as compared to tens of milliwatts for sub type a sensors: a 100 times improvement. The power supply to the sensor head is thus greatly simplified.

In HV applications, the sensor head is often exposed to extremely harsh environments. The temperature range can be as wide as −40 C to +70 C, the relative humidity can be as high as 90%, and the sensor head may be subjected to considerable vibration. can the electro-optic devices used in hybrid optical current/voltage sensors will suffer from aging and drifts due to low/high temperatures, moisture, pressure, vibration, etc., leading to degradation of sensor accuracy and stability. In some current sensors, Rogowski coils are used to detect the alternatim current in the power line. Then an integrator is needed to integrate the output of the Rogowski coil. The capacitor in the integrator is another source of temperature drift which is not readily predictable and is difficult to compensate. The above mentioned drifts set the fundamental limitations to the achievable accuracy of the sensors.

The power industry has extremely stringent requirements for the accuracy of the current or voltage sensors, for example, for revenue metering, no greater than +/−0.2% error in amplitude measurement, and no greater than +/−1.5 minutes of arc in phase angle measurement.

Some type of improvement is needed for the fiber optic hybrid current and voltage sensors to meet the above mentioned accuracy.

### SUMMERY OF THE INVENTION

U.S. Pat. No. 7,279,884 disclosed a current sensor with automatic temperature compensation. This is achieved by placing a number of magnetic sensors and a permanent magnet or a current carrying solenoid around a current carrying conductor. The permanent magnet of the solenoid provides a known and stable magnetic field for the sensor to This invention describes a method to automatically cancel the above mentioned aging and drifts in the opto-electric devices by adding a reference signal channel into the device driving circuitry. The current or voltage under measurement has a finite bandwidth, for example, in power transmission system, the fundamental frequency is 40-60Hz. In some cases, it is desirable to measure harmonics of the fundamental as well, Therefore, a broader bandwidth is required. If the electro-optic device in the sensing head has a bandwidth wider than this, it is possible to add a reference channel, which is outside this main signal band, to the driving circuitry. Nowadays an electric signal generating circuit with high accuracy and stability is readily realizable, which is also power efficient. Such signal generating circuitry can be used as this added reference channel.

The main channel signal can be expressed as:

Sigₘₐᵢₙ=Lp(T,t)·Fl(T,t)·M(T,t)·R(T,t)·Bpₘₐᵢₙ(T,t)

and the reference channel as :

Sig_{ref}=Lp(T,t)·Fl(T,t)·M(T,t)·R(T,t)·Bp_{ref}(T,t)

After the division:

$$\frac{{Sig}_{main}}{{Sig}_{ref}} = \frac{{Bp}_{main} ( T , t )}{{Bp}_{ref} ( T , t )}$$

where Lₚ is the optical power from the light source, Fl the fiber loss, M the opto-electric device's modulation coefficient, R the optical receiver's responsivity, and Bpₘₐᵢₙ and Bp_{ref} the insertion losses of the main signal's band pass filter and reference signal's band pass filter, respectively. Note they are all functions of T, temperature, and t, time (aging).

It can be seen that all the drifts and aging in the light source, in the transmission fiber, in the modulation coefficient of the electro-optic device, and in the optical receiver's responsivity, are factored out. The only remaining drifts are in the main channel's band pass filter and in the reference channel's band pass filter. Because these two filters are at the low voltage side in the work room, they can be easily temperature stabilized.

### BRIEF DESCRIPTION OF THE DRAWINGS

FIG. 1 shows an optical current sensor with a reference signal added to the main signal via a summing circuitry.

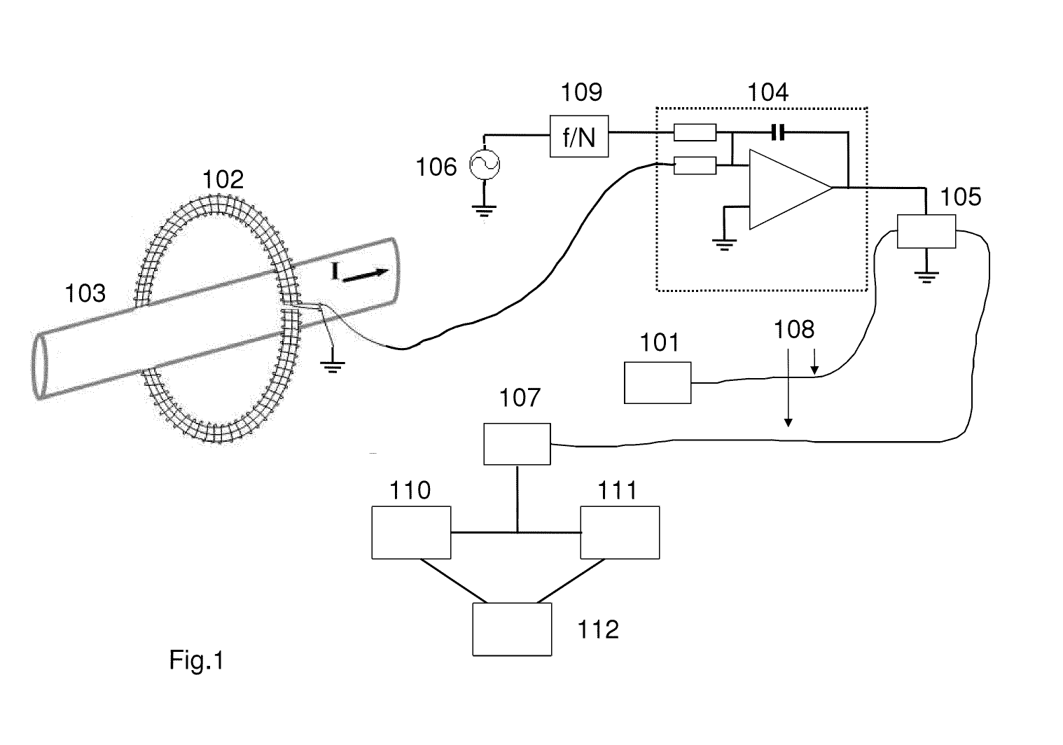

FIG. 2 shows an optical voltage sensor with a reference signal added to the main signal via a summing circuitry.

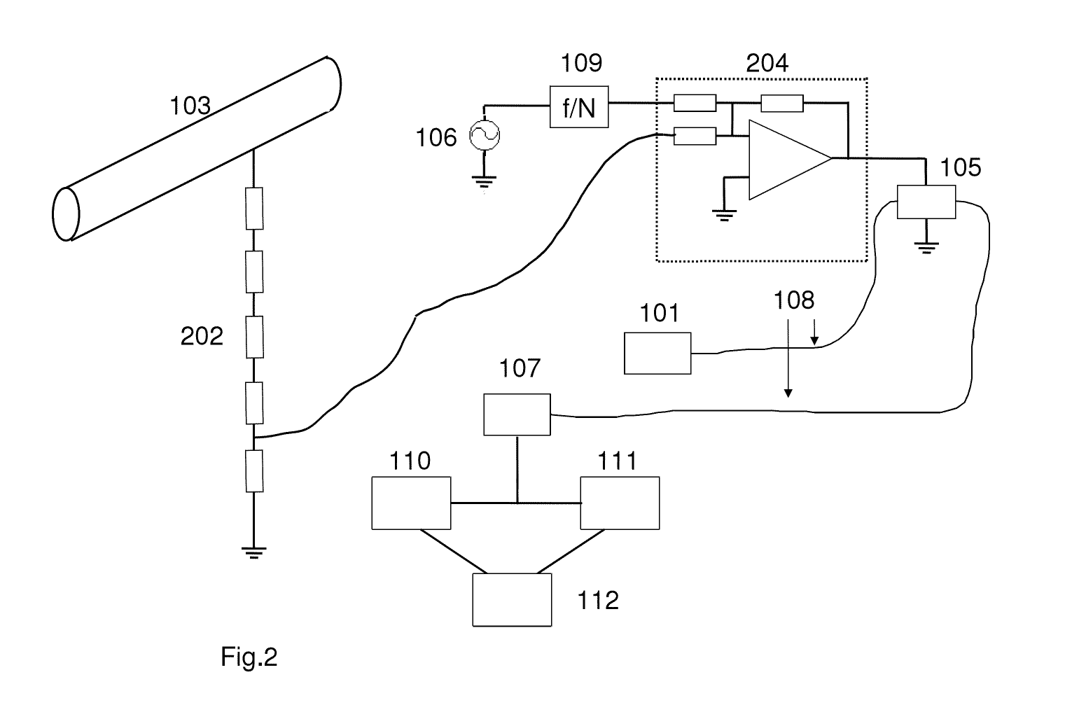

FIG. 3 shows the wave form of the reference signal combined with the main signal, and the separated reference signal and main signal after passing through band pass filters.

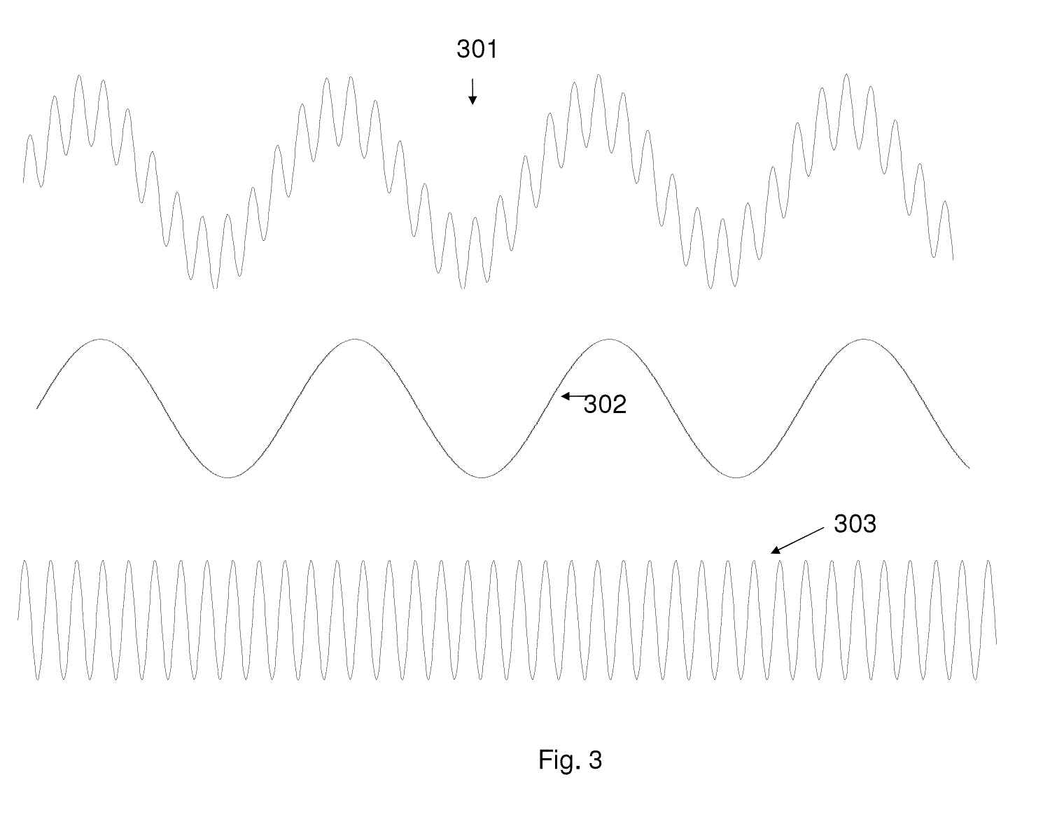

### DETAILED DESCRIPTION OF THE PREFERRED EMBODIMENTS

### First Preferred Embodiment

An optical AC current sensor for applications including but not limited to 50 Hz or 60 Hz power lines employs a light source 101, a Rogowski coil 102 surrounding the current carrying HV conductor 103 to convert AC current into an AC voltage, a summing integrator 104 that sums and integrates the input voltages, an electro-optic device 105 that modulates the input CW light signal, a reference signal generator 106, and an optical receiver 107. Optical fibers 108 connect the light source and the optical receiver with the electro-optic device. The reference signal is added to one of the integrator's inputs. This reference signal is generated by a crystal oscillator and a frequency divider 109 divides the frequency down to a frequency substantially higher than 50 or 60 Hz, for example, 512 Hz. The wave form is square. The power supply to the circuit is provided by a high precision voltage reference with no more than 0.02% drift in the −40° C.-+60° C. temperature range, which is negligible for a sensor accuracy of the 0.2% class. The crystal oscillator and the high precision 2.5V power supply ensures the stability of the reference signal. When this reference signal is added to the main signal (50 or 60 Hz, sinusoidal) obtained from the Rogowski coil, both signals are integrated in an integrator. After the integrator, the square wave reference signal becomes triangular, while the sinusoidal main signal is sinusoidal but is phase shifted by 90 degree. The output of the integrator then drives the electro-optic device. Due to the limited bandwidth of the electro-optic modulator and of the optical receiver, in the received electrical signal 301 both the main signal and the reference signal look like sinusoidal. Then, two band pass filters 110 and 111 centered at the main signal and the reference signal, respectively, separate these two signals into their respective paths. The main signal 302 and the reference signal 303 are then A/D converted and processed in the signal processing unit 112, and the main signal is divided by the reference signal. Since the two signals originate from same light source, and pass through the same electro-optic device, integrator, and optical receiver, temperature drifts and aging in the common path for the two signals, are factored out by the division performed in the signal processing unit.

### Other Preferred Embodiment

An optical AC voltage sensor for applications including but not limited to 50 Hz or 60 Hz high voltage power lines employs a light source 101, a resistive voltage divider 202 to obtain the main signal from the HV conductor 103, a reference signal generator 106, a summing amplifier 204, an electro-optic device 105 to modulate the input CW light signal, and an optical receiver 107. The reference signal is added to one of the summing amplifier's input ports. The reference signal is generated in the same way as described in the first preferred embodiment. The optical receiver and the signal processing after the optical receiver are the same as in the first embodiment.

What is claimed is:

1. A method to compensate temperature drift and aging of a hybrid fiber optic current sensor or voltage sensor comprising of
a. a reference signal generator;
b. a summing circuitry which combines the reference signal and the main signal into a combined signal
c. an electro-optic device;
d. an optical receiver which converts optical signal into electric signal;
e. two electric band pass filters which separates said main signal said reference signal in said optical receiver into respective paths;
f. a signal processing unit which calculates ratio of said main signal to said reference Signal;

2. Said reference signal generator is a stable, low power consumption, electronic signal generating circuitry with a frequency outside said main signal frequency band;

3. Said main signal in said hybrid fiber optic current sensor is obtained from current carrying conductor via an iron core coil, or an air core coil (also called Rogowski coil), or a shunt resistor, or a Hall effect device;

4. Said main signal in said fiber optic voltage sensor is obtained from HV conductor via a resistive voltage divider, or a capacitive voltage divider, or a condenser antenna;

5. Said summing circuitry is an electronic circuits which sums two or more input signals and outputs the sum;

6. Said electro-optic device is an electrically controlled optical attenuator or modulator which modulates input optical signal by an electric signal;

7. Said signal processing unit is a digital signal processor which is capable of mathematical operations, and in particular, is capable of performing division of signals.
